(19) United States
(12) Patent Application Publication
(10) Pub. No.: US 2010/0131617 A1
(43) Pub. Date: May 27, 2010

(54) METHOD AND SYSTEM FOR DIFFERENTIAL TRANSMISSION OF WEB PAGE STRUCTURES

(76) Inventors: John Osborne, Incline Village, NV (US); James H. Schmidt, Incline Village, NV (US)

Correspondence Address: IAN F. BURNS & ASSOCIATES, 4790 Caughlin Parkway #701, RENO, NV, 89519-0907, US

(21) Appl. No.: 12/621,102

(22) Filed: Nov. 18, 2009

Related U.S. Application Data
(60) Provisional application No. 61/117,723, filed on Nov. 25, 2008.

(51) Int. Cl. G06F 15/16

(52) U.S. Cl. 709/219

(57) ABSTRACT

Because of restricted communications bandwidth and storage, mobile terminals and devices often suffer reduced Quality of Service (QoS) or delays when displaying data or forms associated with web pages or applications that depend on remote data. A method is disclosed for transmitting data as structured collections of objects that can be compared with internal cache collections such that only changed data needs to be transmitted. The structure that represents the data objects is the only component that must be transmitted, resulting in significant reduction of both the data to be transmitted and the number of connections that must be established with the remote server. This results in significantly reduced network and processing overhead, reduced connections, and higher QoS for the mobile application.

### CROSS REFERENCE TO RELATED APPLICATIONS

This application claims priority to U.S. provisional patent application Ser. No. 61/117,723, filed Nov. 25, 2008, the content of which is herein incorporated by reference.

### FIELD OF THE INVENTION

The present invention relates generally to the fields of computer systems and data processing, wireless telecommunications, and in particular to differencing of web page content structures with mobile devices.

### BACKGROUND

Telecommunications devices, in particular mobile phones, were originally targeted at voice communications, but have evolved into complete multimedia and Internet appliances with a variety of digital services including browsers for the World Wide Web and applications which access data over the Internet. In many Internet browsers, it is necessary to keep a connection open during the entire session to transmit information. In wireless devices or networks, it is impractical to keep the connection alive and as such multiple connections and downloads, both expensive in either time or money, must be implemented to complete the display of the page.

In Kirsch, et al. (U.S. Pat. No. 7,370,120) a system for reducing latency by structuring codes relating to compression allows web page caches to be distributed over a persistent network. This reduces the latency and data traffic over the network, but does not reduce the connections on non-persistent networks such as wireless connections.

In Bittinger, et al. (U.S. Pat. No. 6,260,066) a system is disclosed which can minimize traffic flow across a connection by transmitting only altered versions of predefined templates, but it does nothing to reduce the number of connections required for multiple page tags to be evaluated and accessed.

In Imanishi, et al. (U.S. Pat. No. 7,275,057) a differencing engine is disclosed which compares transactions in B to B message exchanges, to transmit changes to a business counterpart. While this minimizes overall traffic flow on a persistent network, it does not act upon generic multiple access web documents nor reduce connectivity requirements in mobile networks.

What is required is a system and method that can improve on the number of connections required to access all of the remote data tags specified on a web page and reduce the overall data that needs to be transmitted.

### SUMMARY OF ONE EMBODIMENT OF THE INVENTION

Advantages of One or More Embodiments of the Present Invention

The various embodiments of the present invention may, but do not necessarily, achieve one or more of the following advantages:

the ability to provide web page data to a mobile device;

the ability to render web page data efficiently on a mobile device;

the ability to provide web page content to a mobile device using minimal connections; and

the ability to efficiently utilize caching of web page content on a mobile device.

These and other advantages may be realized by reference to the remaining portions of the specification, claims, and abstract.

Brief Description of One Embodiment of the Present Invention

In one aspect of the invention, there is provided a method for retrieving web page content onto a mobile device. In a first session between the mobile device and a server, the mobile device retrieves web page data indicating one or more web page elements. From the web page data, the mobile device can determine one or more web page elements of a web page that need to be downloaded to the mobile device. The required to web page elements may be downloaded from the server in one or more subsequent sessions.

In one aspect of the invention, there is provided a server for providing web page content to a mobile device. The server may be configured to receive a web page request from the mobile device in a first connection with the mobile device and provide web page data indicating the web page content during the first connection. Web page content specifically requested by the mobile device may be provided to the mobile device during a second connection.

In one aspect of the invention, there is provided a mobile device that executes an application. The application may be configured to establish a first session between the mobile device and a server to retrieve at least one of a web page element list or a modification list. The web page element list may indicate one or more web page elements of a web page and the modification list may indicate when the one or more web page elements were modified. The application may determine one or more web page elements to be downloaded from the server using at least one of the web page element list and the modification list. The required web page elements may be requested from the server during a second session.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic view of one embodiment of a system for providing web page content to a mobile device;

FIG. 2 is substantially a flowchart of a method for retrieving web page content onto a mobile device; and

FIG. 3 is substantially a flowchart showing an interaction between a mobile device and a server.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

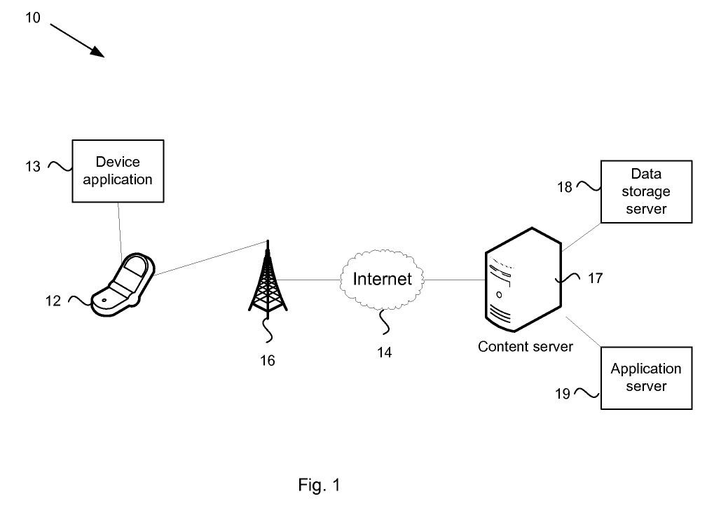

In one embodiment, the present invention provides a method for the transmission of differenced HTML or Web based information on mobile devices. A system for implementing an embodiment of the invention is illustrated in FIG. 1. In the system 10, a wireless or mobile device 12 may connect to one or more content servers 17 through a Web/Internet connection 14 or through another wireless networking system (via mobile towers 16 or similar access points). The content server 17 may include a data storage server 18 and/or an application server 19. Through this network the mobile device receives script pages or other descriptions of content to be rendered to the display screen of the mobile device for the purposes of user interaction or the delivery of content. One or more of these pages may contain links to other information which must be downloaded to complete the rendering of the page at the mobile device.

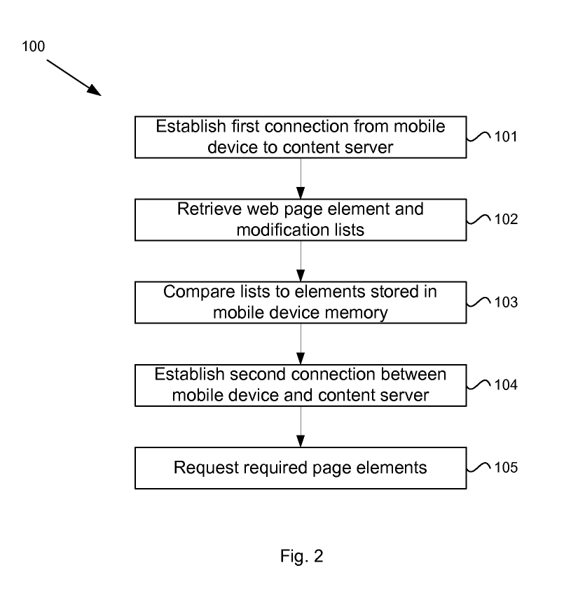

To improve the quality of service and lower costs, the mobile device may retrieve content from the content server using a method illustrated in the flowchart 100 of FIG. 2. At step 101, the mobile device requests web page content by establishing a first session connection with the content server 17. The mobile device retrieves a list of the web page elements and a modification list that details when the web page elements were last modified (step 102). The mobile device 12 then compares the element list to elements cached or otherwise stored in a memory of the mobile device (step 103). For any elements that are cached in the mobile device 12, the mobile device 12 compares a date of caching against a date of modification in the modification list. The mobile device 12 then establishes a second session connection (content retrieval session) to the content server 17 (step 104) and requests any required page elements (step 105) that are not already stored on the mobile device or that are older than the most recently modified version indicated in the modification list.

As shown in FIG. 1, the mobile device 12 may execute a mobile application 13 that processes the web page element and modification lists from the content server 17, compares the cached content in the mobile device with the information in the retrieved lists, and requests only the required content.

In one embodiment, the HTML or XHTML page data of the content server 17 is parsed and converted to a set of object structures, a hierarchical reference list, and last modified list. The application 13 on the mobile device 12 can read this information in one connection, and plan the minimum number of connections required to retrieve any further information that is not already resident in the cache of the mobile device 12. Even if all of the data must be downloaded, the number of connections required is minimized because all of the data can be requested in the same transaction.

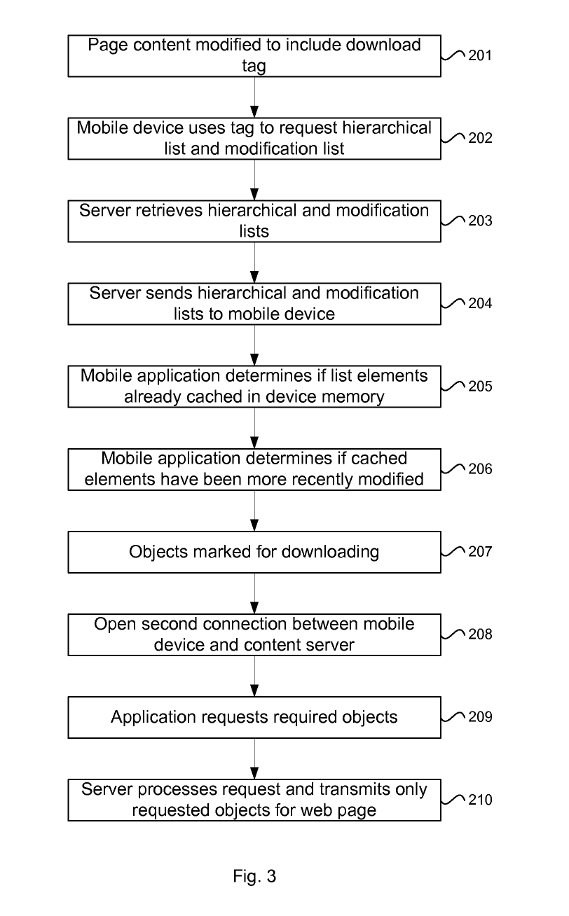

FIG. 3 shows a flowchart 200 demonstrating the interaction between the mobile device and the network. At step 201, a normal page of the content server 17 is modified such that it contains a single tag for downloading all other information required by the page. The application 13 uses this tag to request the Hierarchical Reference and Last Modified lists (step 202). When a page request is received from a mobile device, the server 17 accesses the requested lists (step 203) and then transmits them to the device completing the first connection and transaction (step 204). The application on the mobile device then uses the information in these lists to check permanent and cache storage to determine which, if any, of the objects in the Hierarchical Reference list already exist in memory (step 205) and if it does, is it the same date as or newer than the Last Modified list indicates (step 206). If the object is not stored in the device, or the stored object is older than the Last Modified list indicates, the object is marked for downloading (step 207). Once all of the objects have been checked, a second connection is opened to the server (step 208) and all of the data needed is requested in a single access over the second connection (step 209). The server then checks the returned request and transmits only the objects requested (step 210) completing the second connection and transmission. The application then has all of the data it requires to render the page.

As an example, if the original page had nine elements consisting of style pages, PNG image files, and XHTML tags, nine connections would need to be opened and nine downloads executed using prior art methods. Using the methodology presently described, regardless of the size or complexity of the page being displayed, only the required data is downloaded over just two connections.

In one embodiment, data may already be resident on the mobile device in permanent or semi-permanent fashion, and the phone may always access this baseline data instead of pulling the data from the transmission network. For example a greeting card application described in the Applicant's co-pending patent application Attorney Docket No. 560.9289, the entire contents of which are incorporated herein by reference, may utilize greeting card templates which could be stored in the mobile device's internal memory so that only personalizations of the greeting need be transmitted.

In one embodiment, the data objects from web pages can be flagged as purgeable in the mobile device cache. If a data element is downloaded but flagged as non-purgeable, it can be stored in permanent memory for later use at any time. Purgeable elements can be removed from the cache. This also allows additional long term content to be built up on the fly as the user accesses the data resources that are needed.

A purge date and priority level may be associated with the web page objects so that non-purgeable objects can be deleted over time, eliminating the tendency to fill memory. A purge date and priority level may be assigned either by user interaction or directives from the web site. The purge date and priority level can be used to invalidate non-purge flags older than the purge date or below a given priority setting.

By converting the remote access structures defined in a web page on a dedicated server such that the page elements are converted into a stream of objects, a hierarchical reference list, and a Last Modified list, the presently described embodiments enable both the number of connections required to access data and also the total data transmitted to the device to be minimized. The structure that represents the data objects is the only component that must be transmitted, resulting in significant reduction of both the data to be transmitted and the number of connections which must be established with the remote server. This results in significantly reduced network and processing overhead, reduced connections, and higher QoS for the mobile application.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A method for retrieving web page content onto a mobile device comprising:
(A) establishing a first session between the mobile device and a server;
(B) retrieving web page data indicating one or more web page elements to the mobile device during the first session;
(C) processing the web page data to determine one or more web page elements to be downloaded to the mobile device;
(D) establishing at least one second session between the mobile device and the server; and
(E) downloading the one or more web page elements to be downloaded during the at least one second session.

2. The method according to claim 1 wherein the web page data comprises data indicating one or more web page elements of a web page and data indicating when the one or more web page elements were last modified.

3. The method according to claim 2 comprising comparing the data indicating the one or more web page elements to one or more web page elements stored in at least one memory of the mobile device.

4. The method according to claim 3 wherein determining one or more web page elements to download comprises determining that a web page element indicated in the data indicating the one or more web page elements is not stored in the at least one memory of the mobile device.

5. The method according to claim 3 comprising determining that a web page element stored in the at least one memory of the mobile device is older than a date when the web page element was last modified.

6. The method according to claim 1 comprising closing the first session after retrieving the web page data.

7. The method according to claim 1 comprising assigning a purge date to at least one web page element on the mobile device and purging the at least one web page element from the at least one mobile device memory after the purge date.

8. The method according to claim 1 comprising:
(A) assigning a priority level to at least one web page element; and
(B) selecting a web page element to delete from the at least one memory of the mobile device depending on the priority level of a selected web page element.

9. A server for providing web page content to a mobile device, the server configured to:
(A) receive a web page request from the mobile device in a first connection with the mobile device;
(B) retrieve web page data that indicates web page content in respect of the web page request;
(C) provide the web page data to the mobile device in the first connection;
(D) receive a web page content request from the mobile device in a second session;
(E) retrieve the requested web page content; and
(F) provide the requested web page content to the mobile device in the second session.

10. The server according to claim 9 configured to parse a web page to convert the web page to web page content comprising a set of object structures and web page data comprising a hierarchical reference list that lists the set of object structures and a modification list that indicates when an object structure of the set of object structures was last modified.

11. The server according to claim 10 configured to provide the hierarchical list and the modification list to the mobile device in the first session.

12. The server according to claim 10 configured to provide one or more of the object structures to the mobile device in the second session.

13. A mobile device comprising:
(A) an application executable on the mobile device, the application configured to:
(a) establish a first session between the mobile device and a server;
(b) retrieve from the server during the first session at least one of a web page element list indicating one or more web page elements of a web page and a modification list indicating when the one or more web page elements were modified;
(c) determine one or more web page elements to be downloaded from the server using at least one of the web page element list and the modification list;
(d) establish at least one second session between the mobile device and the server; and
(e) request the one or more web page elements to be downloaded during at least one second session.

14. The mobile device according to claim 13 comprising at least one memory, wherein the application is configured to determine the one or more web page elements to be downloaded by comparing one or more web page elements stored in the at least one memory with at least one of the web page element list and the modification list.

15. The mobile device according to claim 14 wherein the application is configured to:
(A) determine that a web page element on the web page element list is not stored in the at least one memory; and
(B) tag the web page element that is not stored in the at least one memory to indicate that the web page element that is not stored in the at least one memory is to be downloaded to the mobile device.

16. The mobile device according to claim 14 wherein the application is configured to:
(A) determine that a web page element stored on the server is a newer version of the respective web page element stored on the at least one memory; and
(B) tag the respective web page element to indicate that the newer version of the web page element is to be downloaded from the server.

17. The mobile device according to claim 13 wherein the application is configured to:
(A) assign a purge date to at least one web page element on the mobile device; and
(B) purge the at least one web page element from at least one mobile device memory after the purge date.

18. The mobile device according to claim 13 wherein the application is configured to:
(A) assign a priority level to at least one web page element; and
(B) select a web page element to delete from at least one memory of the mobile device depending on the priority level of a selected web page element.
